(19) United States
(12) Patent Application Publication
(10) Pub. No.: US 2021/0319652 A1
(43) Pub. Date: Oct. 14, 2021

(54) GAMING CABINET WITH INTEGRATED COMPONENTS

(71) Applicant: Eye-Fi, LLC, Las Vegas, NV (US)

(72) Inventor: Scott Allen Clear, Escondido, CA (US)

(73) Assignee: Eye-Fi, LLC, Las Vegas, NV (US)

(21) Appl. No.: 16/844,428

(22) Filed: Apr. 9, 2020

(51) Int. Cl. G07F 17/32

(52) U.S. Cl. CPC G07F 17/3216

(57) ABSTRACT

A gaming cabinet configured integrate at least one component of a gaming system includes at least one internal housing comprising a first wall that is part of an inner surface of an exterior wall or an inner surface of a floor of the gaming cabinet; a plurality of additional walls that form a unitary body with the first wall; and a cover adapted to be attached to the plurality of additional walls so that the cover, the first wall, and the plurality of additional walls define an enclosure for the component.

### TECHNICAL FIELD

The present disclosure relates generally to gaming cabinets and, more particularly, to gaming cabinets having internal structures for integrating components.

### BACKGROUND

Cabinets for gaming devices (e.g., video poker, video slot machines, or other casino games) are historically made of sheet metal and include many different parts that are assembled together. The more components that a cabinet has, however, the more labor it takes to assemble. This fact in addition to weight considerations means that there is a need to minimize the number of components in such cabinets.

### DRAWINGS

Features of the present techniques may be best understood from the following detailed description taken in conjunction with the accompanying drawings of which:

FIG. 1A is a front elevated view of a gaming cabinet according to an embodiment.

FIG. 1B is a rear elevated view of the gaming cabinet of FIG. 1A.

FIG. 1C is a right side elevated view of the gaming cabinet of FIG. 1A.

FIG. 1D is a left side elevated view of the gaming cabinet of FIG. 1A.

FIG. 2A is a perspective view of the gaming cabinet of FIG. 1A, with a cutaway portion in which a first internal housing according to an embodiment can be seen.

FIG. 2B is a close up view of the internal housings of FIG. 2A.

FIG. 2C is a rear view of the belly door of FIG. 2A.

FIG. 3A is a perspective view of the gaming cabinet of FIG. 1A, with a cutaway portion in which a second, a third, a fourth, and a fifth housing according to an embodiment can be seen.

FIG. 3B is a close up view of the second internal housing of FIG. 3A.

FIG. 3C is a close up view of the third internal housing, the fourth internal housing, and the fifth internal housing of FIG. 3A.

FIG. 4A is a perspective view of the gaming cabinet of FIG. 1A, with a cutaway portion in which an internal speaker housing according to an embodiment can be seen.

FIG. 4B is a close up view of the internal speaker housing of FIG. 4A.

FIG. 5 is a block diagram of a game system whose components are integrated into a cabinet according to an embodiment.

### DETAILED DESCRIPTION

According to various embodiments, a gaming cabinet (for a gaming system) integrates components of a gaming system through the use of at least one internal housing in which: an interior surface of an external wall of the cabinet or an interior surface of a floor of the cabinet serves as a first wall of the internal housing, and a plurality of additional walls that (a) extend from the first wall (e.g., from the interior surface of the cabinet wall or floor), and (b) form a unitary body with (e.g., are part of a single piece of material with) the first wall (e.g., with the cabinet wall or floor). The internal housing further includes a final wall that attaches to the plurality of walls to enclose (e.g., fully enclose) a component.

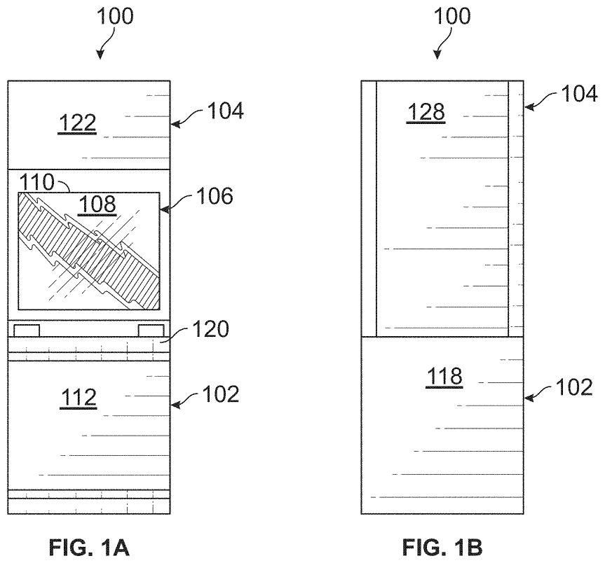

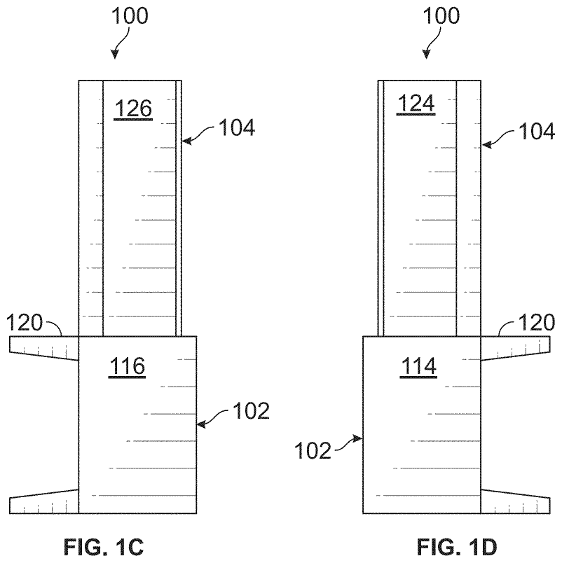

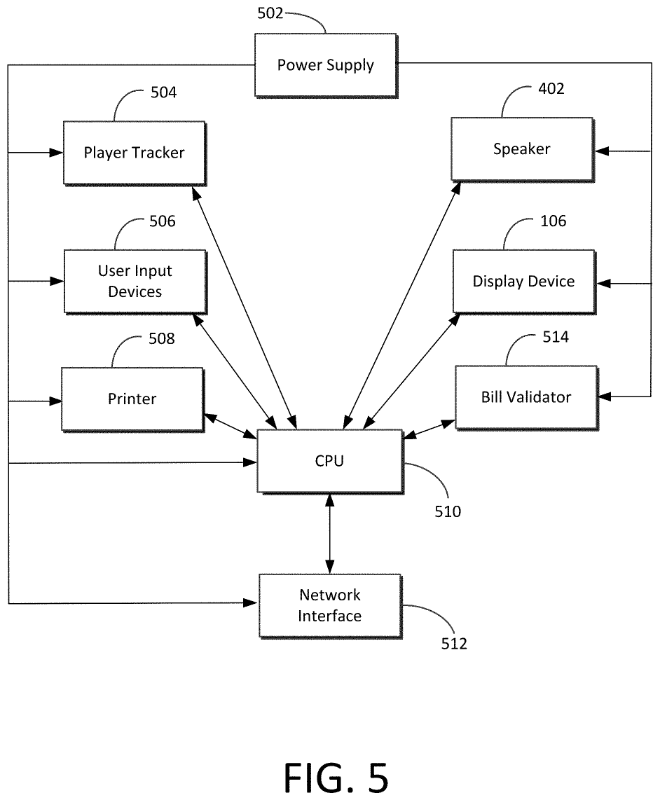

Turning to FIG. 1A, FIG. 1B, and FIG. 1C, a gaming cabinet configured according to an embodiment will now be described. The cabinet, generally labelled 100, includes a lower section 102 and an upper section 104. Disposed within the cabinet 100 is a display device 106 that is disposed within the upper section 104. A screen 108 of the display device is visible through a cutout 110 of the upper section 104 such that the screen 108 is visible from the front side of the cabinet 100. Integrated into the cabinet 100 are components of a game system, which are described in more detail below in conjunction with FIG. 5.

The lower section 102 has a number of outer walls, including a front wall 112, a first side wall 114, a second side wall 116, and a rear wall 118. A user console 120 is attached to, and extends from, the lower section 102 and includes user input devices. In an embodiment, each of the walls 112, 114, 116, 118 has a thickness that ranges from about and including 0.020 inches to about and including 0.5 inches and is made one or more of the following Thermoplastic and Thermoset materials (blends): Acrylonitrile Butadiene Styrene (ABS), Polycarbonate (PC), Polymethyl Methacrylate (PMMA) also known as (Acrylic), High Impact Acrylic, high Impact Polystyrene (HIPS), High Density Polyethylene (HDPE), Polyethylene (PE), polypropylene (PP), Low Density Polyethylene (LDPE), PC/ABS blends, Polyvinyl Chloride (PVC), PBT, Polyamides (PA or Nylons), urethane, epoxy, Polystyrene (PS), Polyethylene Terephthalate (PET), and numerous blends of these as well as compounded versions with glass, cellulose and other performance compound materials. In some embodiments, one or more of the walls 112, 114, 116, 118 is opaque. In other embodiments, one or more of the walls 112, 114, 116, 118 is translucent, which allows the cabinet 100 to be lit up from within without the addition of extra light pipes and extra parts.

The upper section 104 also has a number of outer walls, including a front wall 122, a first side wall 124, a second side wall 126, and a rear wall 128. In an embodiment, each of the walls 122, 124, 126, 128 has the same possible range of thicknesses as described above with respect to the walls 112, 114, 116, 118 and is made one or more of the materials described above with respect to the walls 112, 114, 116, 118.

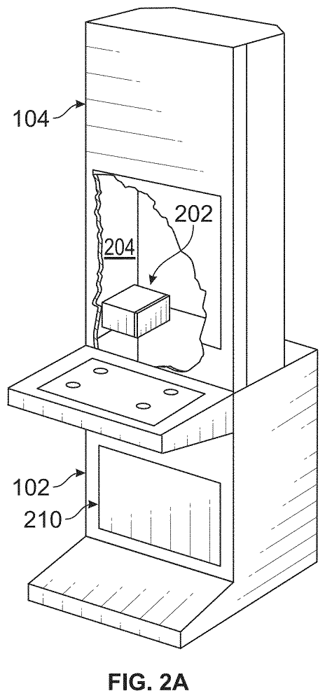

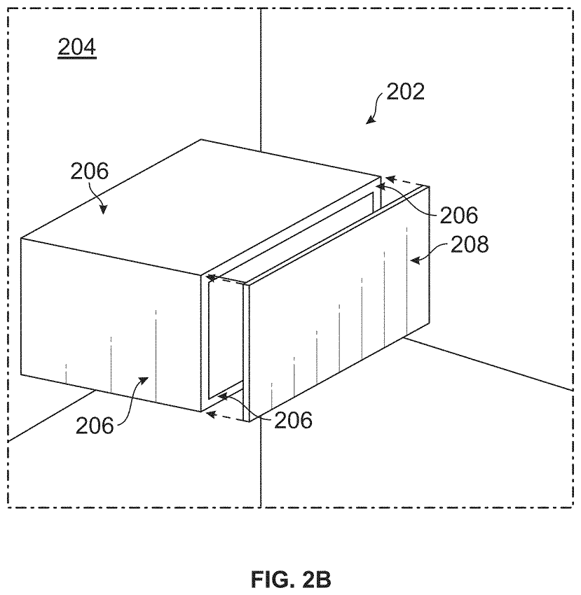

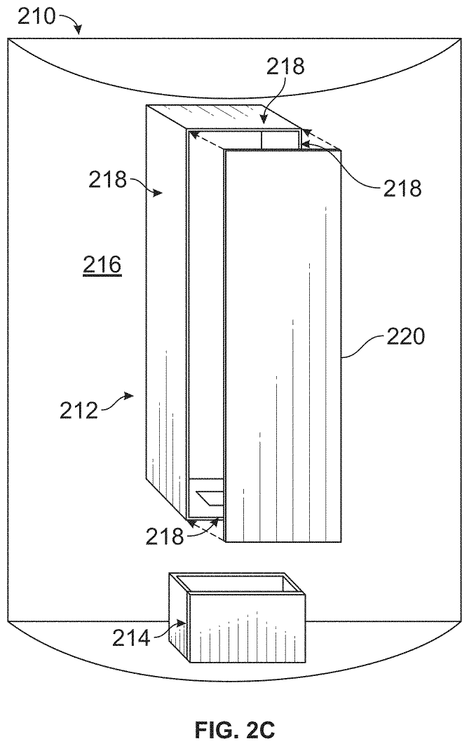

Turning to FIG. 2A and FIG. 2B, in an embodiment, component integration into the cabinet 100 is carried out using internal housings, including a first internal housing 202, within which a printer is disposed. An interior surface 204 of the first sidewall 124 of the upper section 104 functions as a first wall of the housing 202. The internal housing 202 also includes multiple (four in this example) additional walls 206 that extend from the first wall (extend from the interior surface). In an embodiment, the walls 206 form a unitary body with (e.g., are part of the same single piece of material as) the first wall (e.g., are part of the same single piece of material as the first sidewall 124). The internal housing 202 further includes a final (in this case, a sixth) wall 208 that is a separate piece from the rest of the housing 202. The wall 208 takes the form, in this example, of a cover that is configured to attach to the walls 206 so as to enclose the printer.

In an embodiment shown in FIG. 2A, the lower section 102 has a belly door 210. The belly door 210 is removable so as to allow access to the interior of the lower section 102. Turning to FIG. 2C, disposed on the back side of the belly door 210 are a coin chute 212 and a coin tray 214. The coin tray 214 may be in front or back, or under and in front. An interior surface 216 of the belly door 210 serves as a first wall of the coin chute 212. The coin chute 212 further includes additional walls 218 (four in this example) that extend from the first wall (from the interior surface 216). The coin chute 212 further includes a wall 220 that is a separate piece from the rest of the coin chute 212. The wall 220 takes the form, in this example, of a cover that is configured to attach to the walls 218. In an embodiment, the walls 218 form a unitary body with (e.g., are part of the same single piece of material as) the belly door 210.

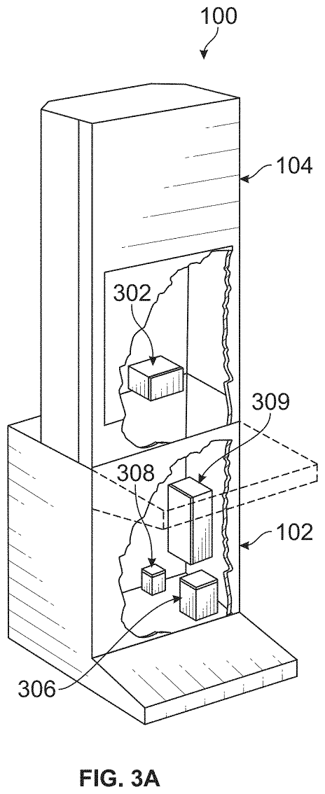

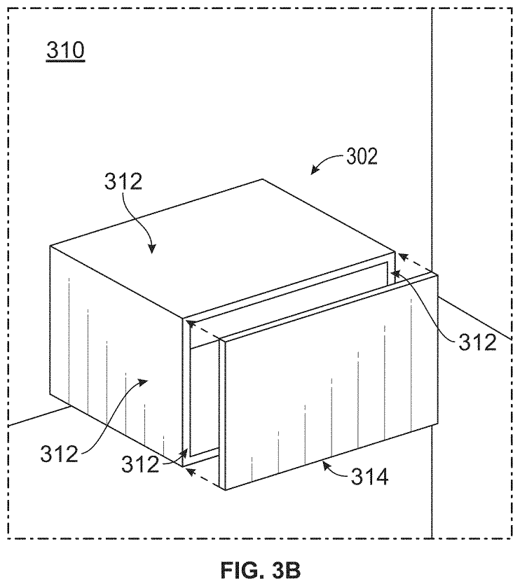

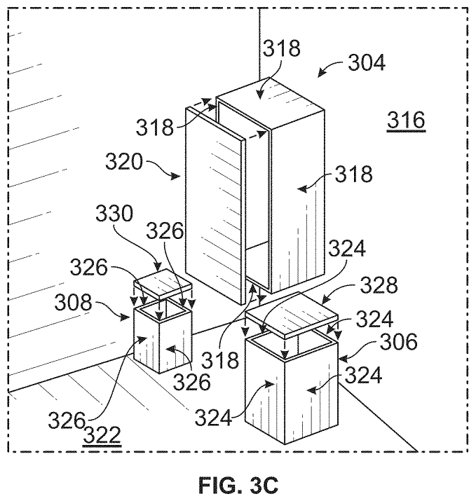

Turning to FIG. 3A, FIG. 3B, and FIG. 3C, in an embodiment, a player tracker, a bill validator, a central processing unit, and a power supply are all integrated with the cabinet 100. More specifically, the cabinet 100 includes a second internal housing 302 for housing the player tracker, a third internal housing 304 for housing the bill validator, a fourth internal housing 306 for housing the central processing unit (CPU), and a fifth internal housing 308 for housing the power supply.

Referring to FIG. 3A and FIG. 3B, an interior surface 310 of the rear wall 128 of the upper section 104 functions as a first wall of the housing 302. The second internal housing 302 also includes multiple (four in this example) additional walls 312 that extend from the first wall (extend from the interior surface 310). In an embodiment, the walls 312 form a unitary body with (e.g., are part of the same single piece of material as) the first wall (e.g., are part of the same single piece of material as the rear wall 128). The internal housing 302 further includes a final (in this case, a sixth) wall 314 that is a separate piece from the rest of the housing 302. The wall 314 takes the form, in this example, of a cover that is configured to attach to the walls 312 so as to enclose the player tracker.

Referring to FIG. 3A and FIG. 3C, an interior surface 316 of the second side wall 116 of the lower section 102 functions as a first wall of the third internal housing 304. The third internal housing 304 also includes multiple (four in this example) additional walls 318 that extend from the first wall (extend from the interior surface 316). In an embodiment, the walls 318 form a unitary body with (e.g., are part of the same single piece of material as) the first wall (e.g., are part of the same single piece of material as the second side wall 116). The internal housing 304 further includes a final (in this case, a sixth) wall 320 that is a separate piece from the rest of the housing 304. The wall 320 takes the form, in this example, of a cover that is configured to attach to the walls 318 so as to enclose the bill validator.

Referring still to FIG. 3A and FIG. 3C, an interior surface 322 of a floor of the lower section 102 functions as a first wall of the fourth internal housing 306 and as a first floor of the fifth internal housing 308. The fourth internal housing 306 also includes multiple (four in this example) additional walls 324 that extend from the first wall (extend from the interior surface 322). Similarly, the fifth internal housing 308 includes walls 326 that extend from the first wall (extend from the interior surface 322). In an embodiment, the walls 324 and the walls 326 form a unitary body with (e.g., are part of the same single piece of material as) the respective first walls (e.g., are part of the same single piece of material as the floor 125). The fourth internal housing 306 and the fifth internal housing 308 each includes respective final (in this case, sixth) walls 328 and 330. The wall 328 is a separate piece from the rest of the fourth housing 306, and the wall 330 is a separate piece from the rest of the fifth housing 308. The wall 328 takes the form, in this example, of a cover that is configured to attach to the walls 324 so as to enclose the CPU. Likewise, the wall 330 takes the form, in this example, of a cover that is configured to attach to the walls 326 so as to enclose the power supply.

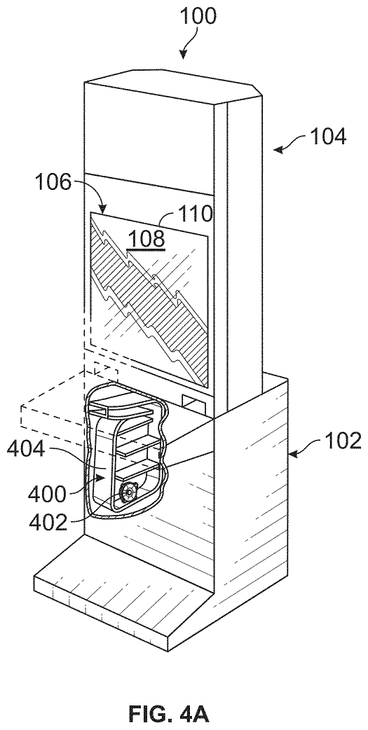

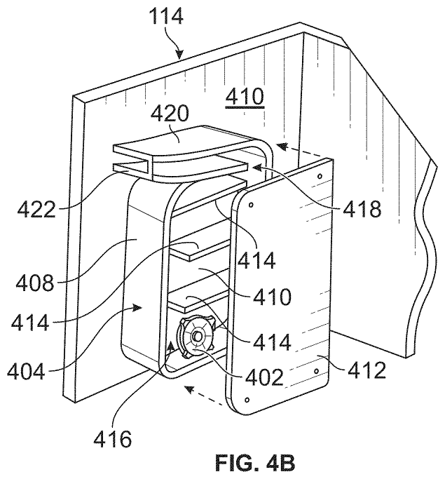

In an embodiment, the game system whose components are integrated with the cabinet 100 includes a speaker system in which at least one speaker is integrated with the cabinet 100. More specifically, the speaker is disposed within an enclosure that is at least partially made up of a wall of the cabinet 100. Turning to FIG. 4A and FIG. 4B, an example of how such an embodiment may be implemented is shown. In this example, a speaker assembly 400 includes a speaker 402 (e.g., a sub-woofer) disposed within an enclosure, referred to herein as speaker housing 404. The speaker housing 404 is made up of a portion of the first side wall 114 of the lower section 102, a first internal wall 408 (which, in some embodiments, is molded together with the first side wall 114 so as to form a unitary body with the first side wall 114) that extends from an inner surface 410 of the first side wall 114, and a second internal wall 412, which is implemented as a removable cover in an embodiment. The second internal wall 412 is shown in FIG. 4B as a removable flat panel, but other implementations are possible (such as a contoured shell).

In an embodiment, the first internal wall 408 has the same ranges thickness as described above with respect to the walls 112, 114, 116, 118 and is made one or more of the materials described above with respect to the walls 112, 114, 116, 118. According to an embodiment, the second internal wall 412 has the same possible ranges of thickness as described above with respect to the walls 112, 114, 116, 118 and is made one or more of the materials described above with respect to the walls 112, 114, 116, 118.

Extending from the inner surface 410 of the first side wall 114 are baffles 414. As with the internal wall 408, the baffles 414 are, in some embodiments, molded together with the first side wall 114 so as to form a unitary body with the first side wall 114 (and, therefore, a unitary body with the lower section 102 of the cabinet 100). The inner surface 410 of the first side wall 114, the internal wall 408, the baffles 414, and the second internal wall 412 define a chamber 416, in which the speaker 402 is disposed, and a maze-like passageway 418 that extends from the chamber 416 to a duct 420. The duct 420 passes through the interior of the cabinet 100 and terminates at an opening in a wall of the cabinet 100, referred to herein as a sound port 422. In an embodiment, the dimensions of the passageway 418 correspond to a folded horn speaker design.

In an embodiment, each of the baffles 414 has the same possible ranges of thickness as described above with respect to the walls 112, 114, 116, 118 and is made one or more of the materials described above with respect to the walls 112, 114, 116, 118. According to an embodiment, the duct 420 has the same ranges thickness as described above with respect to the walls 112, 114, 116, 118 and is made one or more of the materials described above with respect to the walls 112, 114, 116, 118.

When the speaker 402 generates sound (e.g., under the control of a computing device that is running a game for a user), the sound travels from the chamber 416, through the passageway 418, through the duct 420, and is emitted out of the sound port 422.

The gaming system components integrated into the various cabinet embodiments described herein include the components depicted in FIG. 5. The gaming system components include the display device 106, the speaker 402, a power supply 502, a player tracker 504, user input devices 506 (including the components of the user console 120), a printer 508, a CPU 510, a network interface 512, and a bill validator 514. The power supply 502 supplies electricity to the rest of the components. The player tracker 504 accepts user information, such as information stored on a card with a microchip and/or magnetic stripe (e.g., issued by a casino and carried around by a user). The printer 508 prints out things such as game results, cash out information, and promotional offers. The bill validator 514 validates paper currency inserted by the user. The CPU 510 controls the operations of the various components depicted in FIG. 5 and communications with a network (e.g., a casino local area network) via the network interface 512. The CPU 510 includes multiple components such as a memory and logic circuitry (e.g., a microprocessor) that executes software to carry out the operations of a casino game.

It should be understood that the embodiments described herein should be considered in a descriptive sense only and not for purposes of limitation. Descriptions of features or aspects within each embodiment should typically be considered as available for other similar features or aspects in other embodiments. It will be understood by those of ordinary skill in the art that various changes in form and details may be made therein without departing from their spirit and scope.

In an embodiment, a speaker assembly is disposed in a chamber defined by an inner surface of the portion of the cabinet, a first inner wall, and a second inner wall; the second inner wall faces the inner surface, and the first inner wall extends from the inner surface to the second inner wall. According to an embodiment, the speaker assembly further includes baffles extending from the inner surface, wherein the baffles and the inner wall define a maze-like passageway that extends from the chamber and transmits sound generated by the speaker.

In an embodiment, the speaker assembly includes an inner wall extending from an inner surface of the portion of the cabinet and baffles extending from an inner surface of a portion of the cabinet (which acts as a wall of the speaker housing). The baffles and the inner wall define a maze-like passageway that transmits sound generated by the speaker. The speaker assembly in this embodiment further includes a conduit extending from the passageway and to a sound port on the cabinet, wherein the conduit transmits sound generated by the speaker from the passageway to the sound port.

According to an embodiment, a speaker assembly for a gaming cabinet includes a speaker and a speaker housing. The speaker housing in this embodiment includes (a) an inner wall that extends orthogonally from an inner surface of a wall of the cabinet, wherein the inner wall forms a unitary body with the wall of the cabinet and at least partially surrounds the speaker, and (b) a detachable panel disposed substantially parallel to the wall of the cabinet and on the inner wall.

What is claimed is:

1. A gaming cabinet configured integrate at least one component of a gaming system, the gaming cabinet comprising:
at least one internal housing, the internal housing comprising
a first wall that is part of an inner surface of an exterior wall or an inner surface of a floor of the gaming cabinet;
a plurality of additional walls that form a unitary body with the first wall; and
a cover adapted to be attached to the plurality of additional walls so that the cover, the first wall, and the plurality of additional walls define an enclosure for the component.

2. The gaming cabinet of claim 1, wherein the plurality of additional walls comprises four walls extending from the inner surface.

3. The gaming cabinet of claim 3, wherein the four walls comprise a first pair of walls facing one another and a second pair of walls facing one another, and wherein the four walls form four corners.

4. The gaming cabinet of claim 1, further comprising the at least one component of the gaming system disposed within the enclosure.

5. The gaming cabinet of claim 4, wherein the component is a computing device, a bill validator, a speaker, a power supply, a player tracker, or a printer.

6. The gaming cabinet of claim 1, further comprising an uppers section and a lower section, the lower section including a door having an inner surface and a plurality of walls of an integrated coin slot extending from the inner surface.

7. A gaming cabinet configured integrate a plurality of components of a gaming system, the gaming cabinet comprising:
an internal housing integrated into an external wall of the gaming cabinet, the internal housing comprising
a first plurality of internal walls that extend from and form a unitary body with an inner surface of the exterior wall; and
a cover adapted to be attached to the plurality of internal walls, wherein the inner surface, the plurality of internal walls, and the cover define a first enclosure;
an internal housing integrated into a floor of the gaming cabinet, the internal housing comprising
a second plurality of internal walls that extend from and form a unitary body with an inner surface of the floor; and
a cover adapted to be attached to the plurality of internal walls, wherein the inner surface, the plurality of internal walls, and the cover define a second enclosure.

8. The gaming cabinet of claim 7, wherein the first plurality of walls comprises four walls, including a first pair of walls facing one another and a second pair of walls facing one another, and wherein the four walls form four corners.

9. The gaming cabinet of claim 7, wherein the second plurality of walls comprise four walls, including a first pair of walls facing one another and a second pair of walls facing one another, and wherein the four walls form four corners.

10. The gaming cabinet of claim 7, further comprising the first component disposed within the first enclosure.

11. The gaming cabinet of claim 7, further comprising the second component disposed within the second enclosure.
